(19) United States
(12) Patent Application Publication
(10) Pub. No.: US 2016/0126081 A1
(43) Pub. Date: May 5, 2016

(54) APPARATUS FOR CHARGING OR ADJUSTING THE CHARGE OF AEROSOL PARTICLES

(71) Applicants: Boris Zachar GORBUNOV, Canterbury Kent (GB); PARTICLE MEASURING SYSTEMS, INC., Boulder, CO (US)

(72) Inventor: Boris Zachar GORBUNOV, Kent (GB)

(73) Assignee: PARTICLE MEASURING SYSTEMS, INC., Boulder, CO (US)

(21) Appl. No.: 14/897,567

(22) PCT Filed: Jun. 10, 2014
(86) PCT No.: PCT/EP2014/062053

§ 371 Date: Dec. 10, 2015

(30) Foreign Application Priority Data
Jun. 11, 2013 (GB) 1310355.1

(51) Int. Cl. H01J 49/16; H01J 27/26

(52) U.S. Cl. CPC H01J 49/168; H01J 27/26

(57) ABSTRACT

The invention provides an apparatus for charging or altering the charge of gas-entrained particles in an aerosol, the apparatus comprising:

(a) an ion generating chamber (1) containing a first electrode (2) for generating a corona discharge, the first electrode (2) being connected to a power supply of sufficiently high voltage to create the corona discharge; the ion generating chamber (1) having an ion outlet (10) through which ions generated by the corona discharge can leave the chamber (1);
(b) a particle charging chamber (5) in which charging or altering the charge of gas-entrained particles in an aerosol takes place, the particle charging chamber (5) being in fluid communication with the ion generation chamber (1) and having an inlet and an aerosol outlet; and
(c) an electrically non-conductive interface body (7) positioned between the aerosol particle charging chamber (5) and the ion generating chamber (1), the interface body (7) having a hollow interior which is in fluid communication with the ion generating chamber (1) and the aerosol particle charging chamber, and having a gas inlet (8) through which a stream of gas can be introduced into the hollow interior of the interface body (7).

The invention relates to an apparatus for charging or adjusting the charge of aerosol particles by using corona discharge. More particularly, the invention relates to an apparatus where an ion generating region and a particle charging zone of the apparatus are spatially separated to reduce multiple charging and achieve greater long term charging stability.

### BACKGROUND OF THE INVENTION

There is currently a great deal of concern about the health effects of nano-particles and micro-particles emitted unintentionally into the air. For example, a considerable increase in respiratory illness and allergies in the UK in recent years has been associated in part with particles emitted by diesel engines and other combustion processes. Whilst the main focus has been on diesel emissions, attention is turning to other potential sources such as power generation using fossil fuels, incineration, nuclear power generation and aircraft emissions. All heavy industries involving processes emitting fumes have potential problems with the emission of aerosol particles. Such processes include smelting, firing, glass manufacture, welding, soldering, nuclear power generation and incineration. There is also concern amongst consumer companies that use enzymes in washing powders, powder coatings and fibres used in disposable nappies and other products could cause problems. In addition, the US EPA is becoming increasingly concerned about gasoline engine emissions.

Nano-particles and nano-objects are known to produce toxic effects. For example, they can cross the blood-brain barrier in humans and gold nano-particles can move across the placenta from mother to foetus. Early studies with PTFE (polytetrafluoroethylene) particles around 20 nm in diameter showed that airborne concentrations of a supposedly inert insoluble material lower than 50 μg/m³ could be fatal to rats.

In addition to concerns from a health perspective, the elimination or control of airborne particles is important in maintaining standards in the many thousands of clean rooms in the micro-electronics, pharmaceutical, medical, laser, and fibre optics industries.

Small particles can be classified as shown in Table 1 below.

TABLE 1

| | Aerodynamic Equivalent |
|---|---|
| Term | Particle Size Range |
| Dust | dp > 10 μm |
| Coarse particles | 2.5 μm < dp < 10 μm |
| Fine particles | 100 nm < dp < 2.5 μm |
| Nano-particles or ultrafine | 1 nm < dp < 100 nm |
| particles | |

The term “nano-particles” is used to refer to particles having an aerodynamic particle size in the range from 1 nm to 0.1 μm (100 nm).

For spherical particles, the aerodynamic particle size is the geometric diameter of the particle. Real particles in the air often have complicated shapes. For non-spherical particles, the term “diameter” is not strictly applicable. For example, a flake or a fibre has different dimensions in different directions. Particles of identical shape can be composed of different chemical substances and have different densities. The differences in shape and density cause considerable confusion in defining particle size.

The terms “aerodynamic particle size” or “aerodynamic diameter” are therefore used in order to provide a single parameter for describing real non-spherical particles having arbitrary shapes and densities. As used herein, the term “aerodynamic diameter” is the diameter of a spherical particle having a density of 1 g/cm³ that has the same inertial property (terminal settling velocity) in air (at standard temperature and pressure) as the particle of interest. Inertial sampling instruments such as cascade impactors enable aerodynamic diameter to be determined. The term “aerodynamic diameter” is convenient for all particles including clusters and aggregates of any forms and density. However, it is not a true geometric size because non-spherical particles usually have a lower terminal settling velocity than spherical particles. Another convenient equivalent diameter is the diffusion diameter or thermodynamic diameter which is defined as a sphere of 1 g/cm³ density that has the same diffusivity as a particle of interest.

The investigation and monitoring of aerosol particles in the atmosphere has been hampered by a shortage of instruments which can take measurements over a wide particle size range but which are sufficiently inexpensive, robust and convenient to be used on a widespread basis.

Instruments for measuring and selecting aerosol particles can be based upon the electrical mobility of the particles; see for example: Flagan, R. C. (1998): History of electrical aerosol measurements, Aerosol Sci. Technol., 28(4), pp. 301-380. One such instrument is a Differential Mobility Particle Sizer (DMPS) which can be used to determine the size distribution of particles in an aerosol. A DMPS consists of a Differential Mobility Analyzer (DMA), which transmits only particles with a certain size, and a Condensation Particle Counter (CPC), which counts the particles. One of the main elements of a DMA or DMPS is a particle charging device that enables neutral particles to be charged to a known predetermined degree.

Aerosols in industrial and residential areas often exhibit varying proportions of charged and electrically neutral particles. The quantification of aerosols with DMPS requires particles to be of a defined and known charge state. The known charge state can be achieved by treating aerosols with radioactive sources that redistribute charged and neutral particles in the aerosol according to a known proportion.

Radioactive sources initially emit ionizing radiation which produces positive and negative ions in the gas medium. The gas ions subsequently charge or recharge aerosol particles (e.g. Fuchs, N., On the Stationary Charge Distribution on Aerosol Particles in a Bipolar Ionic Atmosphere, Geofis. Pura App., Vol. 56, 1963, pp. 185-192).

The use of radioactive sources is limited by several disadvantages:
The safety requirements concerning the radioactive source are high.
The costs of purchase and maintenance are very high.
The charging efficiency for small particles (dp<30 nm) is very low.
Larger particles (dp>100 nm) are subject to multiple charging when a particle can carry more than 1 elementary electric charge.
It is very difficult or impossible to increase charging efficiency or decrease multiple charging in devices built on the radioactive charging principle.

The charging of aerosol particles using a corona discharge is capable in principle of increasing the charging efficiency of small particles and decreasing or eliminating charges. However, several problems need to be overcome in order to provide a corona-based device which is capable of replacing radioactive charging devices. These problems include:
ozone generation at higher voltage needed to generate corona discharge;
ensuring stability of the corona discharge;
contamination of the surface of the corona emitting electrode with chemical compounds formed by chemical reactions of air constituents with ions and other species generated in the corona discharge; and
the instability of the corona discharge at low currents.
   (See e.g. Romay, F., Liu, B., Pui, D., A Sonic Jet Corona ionizer for Electrostatic Discharge and Aerosol Neutralization, Aerosol Sci. Tech., Vol. 20, 1994, pp. 31-41).

The contamination of the surfaces of corona emitting electrodes can represent a substantial problem, particularly if it is desired to provide a miniaturized instrument. The corona discharge ions react with particles and/or gas molecules to form deposits (often appearing as a white “beard”) on the electrode. The deposits reduce the corona emissions from the electrode and consequently higher voltages are required in order to provide the same level of corona discharge. The increased voltage in turn increases the likelihood of deposits forming, reduces charging efficiency and increases the likelihood of multiple charging of particles. To avoid these problems, electrodes will need to be mechanically cleaned on a regular basis. Mechanical cleaning of electrodes is possible for larger electrodes (e.g. electrodes more than 0.5 mm thick) but is not really feasible for the very small electrodes (e.g. 0.1 mm thickness) that would need to be used if the instrument is to be miniaturized, for example in portable instruments.

Several devices in which aerosols are brought into direct contact with electric discharges are described in Hinds, W., Kennedy, N., An Ion Generator for Neutralizing Concentrated Aerosols, Aerosol Sci. Tech., Vol. 22, 2000, pp. 214-220. The Hinds article discloses inter alia arrangements with two opposing electrodes in a channel that accommodates an aerosol flow. A constant positive or negative high voltage is temporarily applied to each of the two electrodes and a bipolar corona discharge is generated between the two electrodes. Both electrodes act as active electrodes and produce positive or negative gas ions.

Hinds et al. disclose an apparatus with five electrodes and four points aligned axially in the flow in a 90° arrangement. The four points are biased to the same potential, while the axial electrode forms the antipole (in this case positive). Due to the smaller curvature radii of the four electrodes, more negative than positive charges develop. The arrangement disclosed in Hinds et al. is a complicated arrangement that is expensive and requires regular cleaning of the electrodes.

U.S. Pat. No. 6,861,036 discloses a device for charging and capture of particles comprising a corona discharge that is irradiated by X-rays. It is stated in the patent that X-ray irradiation of a corona discharge improves the charging of ultrafine particles. This method and system is particularly well suited for use with bio-aerosol particles wherein exposure to the corona discharge and X-ray irradiation serves to both capture and inactivate the bio-aerosol particles using a single device. However. X-ray sources are expensive, large, subject to safety restrictions and control. Such drawbacks limit the use of X-ray for charging aerosol particles.

Another way of improving charging efficiency is by producing the necessary ions of both polarities. The ions are introduced into the aerosol space with the aid of a particle-free carrier gas (see Zamorani, E. Ottobrini, G., Aerosol Particle Neutralization to Boltzmann's Equilibrium by AC Corona Discharge, J. Aerosol Sci., Vol. 9, pp. 31-39). This method dilutes the aerosol and may affect the reliability of measurements at low concentrations. In addition, most of the ions are deposited onto the walls or are lost through recombination. This leads to an increase in the ozone yield and can be a limitation for many applications.

Devices that create an electrical discharge in the aerosol space tend to achieve only a charge reduction (Hinds). Neither device can be shown to charge or reverse charge the aerosol into the diffusion-based bipolar charge distribution. A further problem is that considerable deposition on the electrode occurs; see U.S. Pat. No. 7,031,133.

U.S. Pat. No. 5,973,904 discloses a particle charging apparatus which includes a housing having a longitudinal axis extending between an inlet and an outlet of the housing with a stream of aerosol particles flowing parallel to the longitudinal axis. A sheath of clean air is created between the stream of aerosol particles and the housing to reduce charged particle loss. However, the sheath air velocity is not properly controlled and is not high enough to prevent loss of charged particles on the wall. In addition, the particle charging apparatus of U.S. Pat. No. 5,973,904 requires a radioactive isotope to create the discharge and a complicated engineering design to create an axial electric field. These technical features complicate the structure resulting in an increase in cost and preventing miniaturization for use in a portable particle measuring instrument.

U.S. Pat. No. 8,400,750 discloses a corona-based particle charger with a sheath airflow for enhancing charging efficiency. The particle charger comprises a housing which includes a charging chamber containing a discharge wire, the charging chamber having a particle inlet, a sheath air inlet, an outlet and an accelerating channel. A clean sheath of air is guided through the sheath air inlet into the charging chamber to surround charged particles, reducing deposition of charged particles on the inside wall of the housing. A relatively small annular gap of the accelerating channel accelerates the charged particles so that they exit the particle charger rapidly thereby minimizing particle electrostatic loss due to deposition of particles on the inner surface of the housing. Additionally, uncharged particles approach the discharge wire axially, and charged particles move away radially. This assists the charged particles to diffuse rapidly and uniformly, thereby enhancing the charging efficiency. However, a problem with the charger disclosed in U.S. Pat. No. 8,400,750 is that charging efficiency is difficult to change and hence it is difficult to prevent multiple charging of larger particles or increase the charging efficiency of small particles.

At present, therefore, there remains a need for an aerosol particle charger that can be used for long periods without cleaning the electrodes, which has greatly increased reliability, exhibits reduced multiple charging and which lends itself to miniaturisation.

### SUMMARY OF THE INVENTION

An object of the present invention is to create a particle charging device whereby gas ions are produced in an aerosol-free region by means of electrical discharge and are then moved into a separate zone where aerosol particles are introduced and are charged by collision with the ions. By separating the on generating region spatially from the charging region, deposit formation on the corona discharge electrode is substantially reduced and the stability and performance of the device is increased.

Accordingly, in a first aspect, the invention provides an apparatus for charging or altering the charge of gas-entrained particles in an aerosol, the apparatus comprising:

(a) an ion generating chamber containing a first electrode for generating a corona discharge, the first electrode being connected to a power supply of sufficiently high voltage to create the corona discharge; the ion generating chamber having an ion outlet through which ions generated by the corona discharge can leave the chamber;
(b) a particle charging chamber in which charging or altering the charge of gas-entrained particles in an aerosol takes place, the particle charging chamber being in fluid communication with the ion generation chamber and having an inlet and an aerosol outlet; and
(c) an electrically non-conductive interface body positioned between the aerosol particle charging chamber and the ion generating chamber, the interface body having a hollow interior which is in fluid communication with the ion generating chamber and the aerosol particle charging chamber, and having a gas inlet through which a stream of gas can be introduced into the hollow interior of the interface body.

In use, when a suitably high voltage (e.g. a voltage of either polarity having a magnitude in the range from 1000V to 5000V, e.g. 1500V to 4500V or 2000V to 4000V) is applied to the electrode, a corona discharge is created in the ion generating chamber. Ions generated by the corona discharge will diffuse across the chamber. Some of the ions will be captured by the internal walls of the chamber but others will reach the outlet and will move into the hollow interior of the interface body and the particle charging chamber where they will collide with gas-entrained particles (when present) in the gas stream entering the gas inlet in the interface body. The collisions with the particles will result in the particles becoming charged or, where they are already charged, may alter the charge of such charged particles. The charging process will continue as the ions and gas-entrained particles move into and through the particle charging chamber. The output from the aerosol outlet of the particle charging chamber may therefore be an aerosol containing gas-entrained charged particles.

The gas inlet of the interface body receives a stream of ions exiting the ion generating chamber into and/or through the particle charging chamber.

In one embodiment, the gas entering the gas inlet of the interface body can contain the gas-entrained particles in an aerosol. In this embodiment, particles in the aerosol will collide with ions emerging from the ion generating chamber and will be carried by the gas stream through the particle charging chamber. Depending on the geometry of the interior of the apparatus, charging (or charge modification) of the aerosol particles may begin in the hollow interior of the interface body and then continue in the particle charging chamber, or the majority (or substantially all) of the charging or charge modification may take place in the particle charging chamber.

In an alternative embodiment, the gas entering the gas inlet of the interface body is clean gas (e.g. clean air); i.e. is substantially free of air-entrained particles. In this embodiment, the gas entering the gas inlet of the interface body will act as a carrier gas and will carry ions into the aerosol particle charging chamber where they will collide with gas-entrained particles introduced through a further inlet in the aerosol particle charging chamber.

Thus, according to this alternative embodiment, the gas inlet of the interface body receives a stream of substantially particle-free gas and the aerosol particle charging chamber has an inlet for receiving a stream of gas containing gas-entrained particles in an aerosol.

The first electrode is typically electrically insulated from the wall or walls defining the ion generating chamber. The walls of the ion generating chamber may be grounded or under a voltage from −5,000 V to +5,000 V.

In one embodiment, the first electrode is mounted in a wall of the ion generating chamber, a layer of electrically insulating material being interposed between the first electrode and the wall. For example, the first electrode can be mounted in an opening in the wall, the opening being lined with an electrically insulating material, e.g. PTFE.

The first electrode can be formed from, for example solid metals (Au, Ag, Pt) and alloys such as stainless steel or brass. One preferred material from which the electrode is formed is platinum.

The electrode can take the form of a conducting metal wire having a thickness of less than 1 mm, for example from 0.1 to 0.5 mm, or 0.1 to 0.4 mm, for example 0.15 to 0.25 mm. In one embodiment, the electrode is formed from a metal wire having a thickness of approximately 0.2 mm.

The particle charging chamber can be formed from a conductive material, e.g. a metal or an alloy. The particle charging chamber is electrically insulated from the ion generating chamber by the electrically non-conductive interface body or by another intermediate electrically insulating element.

The apparatus can have a second electrode positioned between the ion generating chamber and the particle charging chamber, the second electrode being connected to a second voltage source to control the movement of ions out of the ion generating chamber. The second voltage source to which the second electrode is attached is typically a lower voltage source than the voltage source to which the first electrode is attached. Thus, for example, the second voltage source can be one which is capable of providing a voltage in the range −200 to +200 volts.

The second electrode enables the number of ions emerging from the outlet of the ion generating chamber to be controlled. For example, if a positive potential is applied to the second electrode, the number of positive ions emerging from the ion generating chamber will be reduced. The second voltage source is preferably variable so that the potential applied to the second electrode can be varied according to need.

By controlling the number of ions emerging from the ion generating chamber, it is possible to reduce the multiple charging of larger particles and increase the charging efficiency of smaller particles.

The second electrode can be configured so that it constitutes or forms part of an end wall of the ion generating chamber, the wall having an opening therein defining the ion outlet of the ion generating chamber.

The opening in the electrode is typically relatively narrow. For example, the area of the opening can constitute from 1%-90%, more usually 10% to 80%, or 30-70% or 40-60%, for example approximately 50% of the area of the end wall.

In one embodiment, the second electrode constitutes substantially the entirety of the end wall and is therefore formed from an electrically conductive material. The wall is typically provided with a connector which connects it to a low voltage source as hereinbefore defined.

The second electrode can, for example, take the form of a plate having an opening which constitutes the ion outlet for the ion generating chamber.

The second electrode is electrically insulated from the wall(s) of the ion generating chamber. Accordingly, when the second electrode constitutes substantially the entirety of the end wall, a body of electrically insulating material is preferably located between the end wall and the ion generating chamber.

In an alternative embodiment, the end wall can be formed from an electrically non-conducting material and the second electrode can be set into the end wall.

One or more walls, baffles or other gas-flow modifying structures can be disposed between the gas inlet of the interface body and the particle charging chamber to modify the flow characteristics of the gas stream before it passes into the particle charging chamber. For example, the walls, baffles or other structures can be configured to provide a more uniform laminar flow of gas into and through the aerosol particle charging chamber.

In one embodiment, the hollow interior of the interface body can contain a flow conditioning chamber having the gas inlet at an upstream location thereof and a partition wall and an adjacent gap through which gas may flow at a downstream location thereof, the geometry of the flow conditioning chamber, partition wall and gap being selected so as to provide a desired modification to the flow characteristics of the gas stream before it passes through the particle charging chamber.

Where a second electrode is present and forms an end wall of the ion generating chamber and the interface chamber, the gap adjacent the partition wall can be a gap (preferably a narrow gap) between the second electrode and the partition wall.

The gas inlet of the interface body opens into the flow conditioning chamber so that the gas stream entering the gas inlet flows through the flow conditioning chamber and then onwards into or towards the particle charging chamber. The flow conditioning chamber is configured to modify the flow characteristics of the gas stream. For example, it can be configured so as to smooth the gas flow and to impart more laminar flow characteristics to the gas stream, thereby providing a substantially uniform laminar flow of gas into and through the particle charging chamber.

In one embodiment, the partition wall in the hollow interior of the interface body is an axially oriented annular wall and the flow conditioning chamber is an annular chamber. The annular wall is preferably symmetrical about a longitudinal axis of the apparatus. For example, the annular wall can be of circular, oval or polygonal (e.g. hexagonal or octagonal) cross section. Typically, there is an annular gap (preferably a narrow annular gap) between an edge of the annular wall and the end wall of the ion generating chamber (e.g. when constituted by the second electrode).

The cross sectional area of the gas flow before entering the narrow gap is preferably greater than the cross sectional area of flow in the narrow gap between the annular wall and the end wall of the ion generating chamber. As an example, if the cross-section of the aerosol flow before entering the narrow gap is Saf and the cross sectional area of flow in the narrow gap is Sng then Saf>Sng. The ratio of Saf/Sng should typically be more than 1.1 or preferably more than 2 or even more preferably the ratio should be more than 3.

In one embodiment, an electrically conductive mesh is attached to the second electrode so as to extend across the opening (ion outlet) in the second electrode. The electrically conductive mesh is made from an electrically conductive material and it is in electrical connection with the second electrode.

Examples of solid materials that can be used to form the second electrode include solid metals (Au, Ag, Pt) and alloys such as stainless steel or brass.

The gas entering the gas inlet of the interface body can be air or a pure gas or mixture of gases. For example, instead of air, the gas could be nitrogen gas. Where the gas inlet receives gas intended as a carrier gas rather than a sample gas containing air-entrained particles, the gas can be provided from a particle-free source, for example a cylinder of gas. Alternatively or additionally, a filter can be located externally of the gas inlet. For example, a filter can be located across the gas inlet itself, or a filter can be located upstream of the gas inlet, so that, in either case, carrier gas entering the interface body is free from impurities and especially particulate impurities. Examples of filters include HEPA filters and such filters are well known and do not need to be described in detail here.

In embodiments of the invention where the gas inlet of the interface body is connected to a supply of clean (e.g. particle free) gas, the particle charging chamber may have a separate inlet for receiving a gas stream containing air-entrained particles.

In one particular embodiment, an intermediate mixing chamber is provided, the intermediate mixing chamber being in fluid communication with the gas inlet of the interface body, the ion outlet of the ion generating chamber and the inlet of the particle charging chamber so that, in use, the intermediate mixing chamber receives a mixture of ions and clean gas, the particle charging chamber being located downstream of the intermediate mixing chamber and being provided with a separate inlet for receiving the gas stream containing air-entrained particles.

The intermediate mixing chamber and particle charging chamber may be linked via an opening in a common wall or they may be linked via a conduit.

In a second aspect of the invention, there is provided an apparatus for charging or altering the charge of gas-entrained particles in an aerosol, the apparatus comprising:

(a) a first body member comprising an ion generating chamber containing a first electrode for generating a corona discharge, the first electrode being connected to a power supply of sufficiently high voltage to create the corona discharge; the ion generating chamber having an ion outlet through which ions generated by the corona discharge can leave the chamber;
(b) a second body member comprising a particle charging chamber in which charging or altering the charge of gas-entrained particles in an aerosol takes place, the particle charging chamber being in fluid communication with the ion generation chamber and having an inlet and an aerosol outlet; and
(c) an electrically non-conductive interface body positioned between the first and second body members, the interface body having a hollow interior which is in fluid communication with the ion generating chamber and the aerosol particle charging chamber, and having a gas inlet through which a stream of gas can be introduced into the hollow interior of the interface body.

Particular and preferred embodiments of the second aspect of the invention are as set out above in relation to the first aspect of the invention.

In one embodiment of the second aspect of the invention, the first and second body members and the interface body are arranged contiguously.

In another embodiment, a third body member, which comprises the second electrode, is interposed between the first body member and the interface body.

Where the third body member is formed from an electrically conducting material, a fourth body member, which is formed from an electrically insulating material, may be interposed between the first body member and the third body member.

In another embodiment, a fourth body member, which comprises an intermediate mixing chamber, is interposed between the second body member and the interface body, the intermediate mixing chamber being in fluid communication with the gas inlet of the interface body, the ion outlet of the ion generating chamber and the inlet of the particle charging chamber, wherein the particle charging chamber is provided with a separate inlet for receiving a gas stream containing air-entrained particles.

As with the apparatus of the first aspect of the invention, the intermediate chamber and the particle charging chamber may be linked via an opening in a common wall or they may be linked via a conduit.

In a third aspect, the invention provides a method of charging or altering the charge of gas-entrained particles, which method comprises:
forming ions in a first chamber by means of a corona discharge electrode;
introducing a stream of gas into a second chamber, wherein the second chamber is in fluid communication with the first chamber; and either
(i) when the stream of gas contains air-entrained particles, allowing the mixing of ions emerging from an ion outlet in the first chamber with the stream of gas in the second chamber so as to charge or modify the charge of the air-entrained particles; or
(ii) when the stream of gas introduced into the second chamber is substantially free of air-entrained particles, allowing the mixing of ions emerging from an ion outlet in the first chamber with the said stream of gas in the second chamber, passing the mixture of ions and gas into a third chamber located downstream of the second chamber, and contacting the said mixture of ions and gas in the third chamber with an aerosol containing air-entrained particles received through a separate inlet in the third chamber so as to charge or modify the charge of the air-entrained particles.

In each of the foregoing aspects and embodiments of the invention, the gas stream containing the aerosol of gas-entrained particles is largely kept away from the electrode creating the corona discharge. In consequence, there is less opportunity for the formation of multiple charges on particles to occur and also less opportunity for chemical reactions to take place in the vicinity of the first electrode and produce deposits on the electrode. Therefore, the active life of the electrode is prolonged.

In certain circumstances, it can be advantageous to use a pair of apparatuses of the invention connected sequentially together. For example, the first apparatus in a pair can be set up so that a charged aerosol produced by the first apparatus contains mainly or exclusively of ions of one polarity (e.g. negatively charged ions). In the second apparatus, where the aerosol input consists of the aerosol output of the first apparatus, the aerosols are charged with ions of the opposite polarity (e.g. positively charged). This increases the stability and improves the reliability of the charging.

In another aspect, the invention provides a Differential Mobility Analyzer (DMA) comprising an apparatus for charging or altering the charge of gas-entrained particles in an aerosol as hereinbefore defined and as illustrated below.

In a further aspect, the invention provides a Differential Mobility Particle Sizer (DMPS) comprising a DMA comprising an apparatus for charging or altering the charge of gas-entrained particles in an aerosol as hereinbefore defined and as illustrated below, and a Condensation Particle Counter (CPC).

In further aspect, the invention provides a method for reducing/eliminating multiple charging in a size scanning device e.g. a Scanning Mobility Particle Sizer (SMPS) or Fast Mobility Particle Sizer (FMPS) comprising a particle charging means, for example a controlled corona charger, that enables the charging efficiency or proportion of multiple charges to be varied, reduced or eliminated according to the size of particles or the voltage applied to the DMA of said SMPS or FMPS.

In another aspect, the invention provides a method of charging or altering the charge of gas-entrained particles as hereinbefore defined, using an apparatus comprising a differential mobility analyser (DMA) as hereinbefore defined, wherein charging efficiency and/or proportions of multiple charges are varied, reduced or eliminated according to the size of the particles or the voltage applied to the DMA.

It will be appreciated that as a result of the corona discharge from the first (corona) electrode, there will be a flow of current into and along the electrode. This current can be measured by means of a suitable instrument located between the voltage source and the electrode. Not all of the ions created by the corona discharge will escape from the ion generating chamber and play a part in ionizing the particles in the aerosol. Most of the ions will be collected by the conducting wall of the ion generating chamber but a proportion, for example about 10%, will escape through the ion outlet, the exact proportion depending upon a number of factors including the size of the outlet and the potential of the second electrode (when present). Thus, although the current passing along the first electrode will not provide an exact measurement of the number of ions escaping the ion generating chamber, it will be proportional to the number of ions escaping the ion generating chamber and taking part in the particle ionizing process. This proportionality can be used as a means of controlling the degree of ionisation of the particles. Thus, the apparatus can be set up to produce a known and measurable current which in turn will result in a predictable number of ions leaving the ion generating chamber, and hence a controlled degree of ionisation of the particles.

Accordingly, in another aspect, the invention provides a method of charging or altering the charge of gas-entrained particles as hereinbefore defined (e.g. using a DMA) wherein charging efficiency and/or proportions of multiple charges on the particles are varied by changing the current flowing via the first electrode.

As an alternative (or in addition to) controlling the ionization of the gas-entrained particles by controlling the flow of current into the first electrode, the extent of ionization of the particles can be controlled by varying the voltage supplied to the first and/or second electrodes in the ion generating chamber.

Accordingly, in a further aspect, the invention provides a method of charging or altering the charge of gas-entrained particles as hereinbefore defined (e.g. using a DMA), wherein charging efficiency and/or proportions of multiple charges on the particles are varied by changing the voltage applied to any of the electrodes of the ion generating chamber.

In one embodiment, the extent of charging of the gas-entrained particles is controlled by varying the voltage of the first (corona) electrode.

Accordingly, the invention provides a method of charging or altering the charge of gas-entrained particles as hereinbefore defined (e.g. using a DMA), wherein charging efficiency and/or proportions of multiple charges on the particles are varied by changing the voltage applied to the first electrode.

Further aspects and features of the invention will be apparent from the specific embodiments described below and illustrated in FIGS. 1 to 9.

### BRIEF DESCRIPTION OF THE DRAWINGS

FIG. 1 is a schematic side sectional view of an aerosol particle charging apparatus according to a first embodiment of the invention.

FIG. 2 is a schematic side sectional view of an aerosol particle charging apparatus according to a second embodiment of the invention.

FIG. 3 is a schematic side sectional view of an aerosol particle charging apparatus according to a third embodiment of the invention.

FIG. 4 is a schematic side sectional view of an aerosol particle charging apparatus according to a fourth embodiment of the invention.

FIG. 5 is a schematic side sectional view of an aerosol particle charging apparatus according to a fifth embodiment of the invention.

FIG. 6 is a long term corona performance test (positive corona) showing ion concentration (ion counts) vs. time.

FIG. 7 is an ozone concentration vs. corona voltage for a positive corona.

FIG. 8 shows a graph comparing the charging efficiency of a unipolar corona (black squares) with an aerosol particle neutralizer (white circles) vs. particle diameter.

FIG. 9 shows a graph of a typical size distribution obtained with the third embodiment of the invention. The size dp is in nm and dN/d Log dp is in cm⁻³.

### DETAILED DESCRIPTION OF THE INVENTION

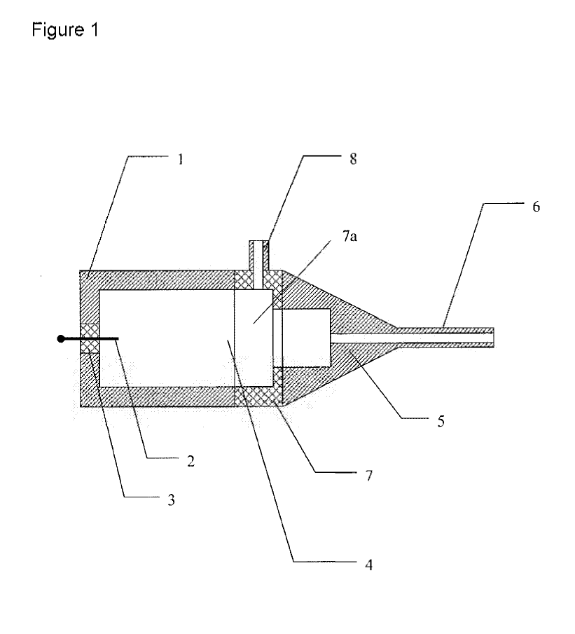

The invention will now be illustrated in greater detail by reference to the specific embodiments described below and illustrated in the accompanying drawings FIGS. 1 to 9.

An apparatus according to a first embodiment of the invention is shown in FIG. 1. The apparatus comprises an ion generating chamber 1, mounted in the wall of which is a first electrode 2 for generating a corona electric discharge. The first electrode 2 is electrically insulated from the body of the ion generating chamber 1 by means of a sealing element or plug 3 formed from an electrically insulating material. The electrode 2 is connected to a high voltage power supply (not shown) which is capable of applying a potential of up to about 5000 volts to the electrode. At the end of the ion generating chamber opposite the first electrode is an opening 4 through which ions may leave the ion generating chamber. The walls of the ion generating chamber are formed from an electrically conducting material such as a metal or an alloy (e.g. stainless steel)

Adjacent the ion generating chamber 1 and attached thereto is an electrically non-conductive interface body 7 which has a hollow interior 7a and a gas inlet 8 for receiving a stream of gas containing an aerosol of gas-entrained particles. The body 7 is formed from an electrically non-conducting material such as PTFE.

Connected to the interface body 7 is a particle charging chamber 5 which is formed from an electrically conducting material such as stainless steel and has an aerosol outlet 6. The interface body, which is formed from an electrically non-conducting material, provides electrical insulation between the ion generating chamber 1 and the particle charging chamber 5.

The ion generating chamber 1, the particle charging chamber 5 and the interface 7 typically have axial symmetry.

In use, a stream of gas containing an aerosol of gas-entrained particles is introduced through the gas inlet 8. A high voltage (for example, approximately 5000V) is applied to the first (corona) electrode 2 and a corona discharge is generated in the ion generating chamber 1 (FIG. 1). The ions move from the tip of the corona electrode 2 in the electric field created by the corona. Some ions are captured by the internal walls of the chamber 1 but some reach the opening 4 of the chamber 1 and enter the hollow interior of the interface body 7. In the hollow interior of the interface body 7, ions collide with aerosol particles coming from the inlet 8 as a result of Brownian diffusion. As a result of the collisions, uncharged particles in the aerosol will become charged and particles with existing charges will undergo changes to their charged state. The charging/alteration of charging will begin inside the hollow interior of the interface body 7 and continue as the gas stream from the gas inlet 8 moves the mixture of gas, ions and particles into and through the particle charging chamber 5 and the conduit leading to the outlet 6. At the outlet 6, the exiting gas stream contains charged particles which can then be measured or characterised by a connected instrument.

Am advantage of the apparatus shown in FIG. 1 is that the gas stream entering the gas inlet 8 does not impinge to any significant extent on the region covered by the corona discharge from the electrode 2. Therefore, the likelihood of particles in the aerosol reacting and forming deposits on the first electrode is greatly reduced.

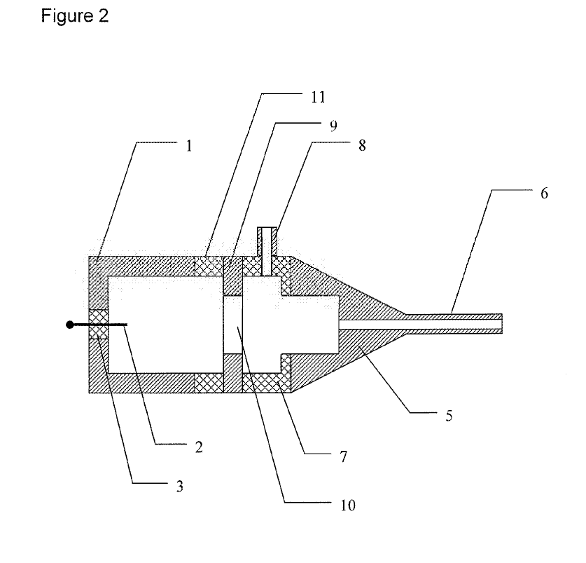

An apparatus according to a second embodiment of the invention is illustrated in FIG. 2. The embodiment of FIG. 2 has in common with the embodiment of FIG. 1 the features identified by the numerals 1 to 3 and 5 to 8. However, the apparatus of FIG. 2 additionally comprises a conductive second electrode in the form of a plate 9 formed from an electrically conducting metal material and having a narrow central opening 10. The second electrode 9 is positioned between the ion generating chamber 1 and the interface body 7. Because the second electrode is formed from an electrically conductive material, a body of electrically insulating material 11 is interposed between the second electrode and the ion generating chamber 1 to ensure that the second electrode and ion generating chamber are electrically insulated from one another. The second electrode 9 is connected to a DC or AC power supply, preferably with a voltage from −200 to +200 volts.

The presence of the second electrode 9 enables the ion concentration leaving the ion generation chamber 1 through the ion outlet 4 and opening 10 to be controlled by applying a voltage of desired polarity and magnitude to the second electrode. For example, if a positive potential is applied to the second electrode 9, the number of positive ions passing thorough the opening 10 into the hollow interior of the interface body 7 and particle charging chamber 5 will be reduced. A benefit of this arrangement is that it reduces multiple charging of larger particles and increases the charging efficiency of smaller particles. An additional benefit is that it increases still further the spatial separation between the corona discharge region and the particles in the aerosol entering through the gas inlet 8 and thereby reduces still further the likelihood of deposits forming on the first electrode 2.

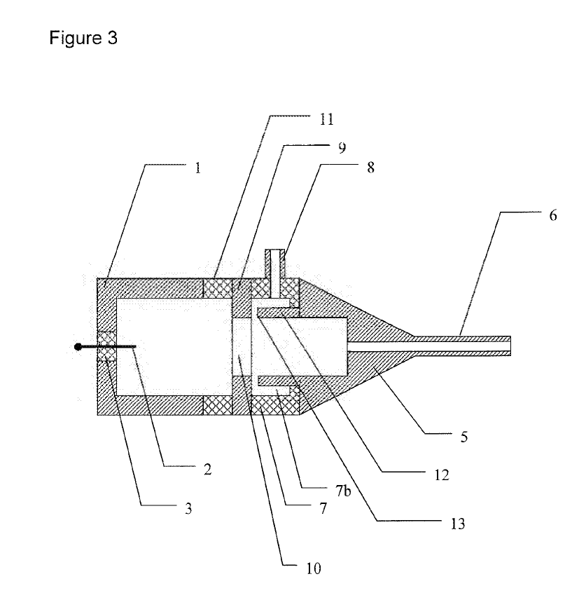

An apparatus according to a third embodiment of the invention is illustrated in FIG. 3. The embodiment of FIG. 3 has in common with the embodiment of FIG. 2 the features identified by the numerals 1 to 3 and 5 to 11. Thus, the apparatus comprises an ion generating chamber 1 having a first electrode 2 for generating a corona electric discharge. The first electrode is electrically insulated from the body of the ion generating chamber 1 by means of a plug or layer 3 of electrically insulating material and is connected to a high voltage power supply (not shown). As with the embodiment of FIG. 2, the apparatus comprises an electrically nonconductive interface body 7 located between the particle charging chamber 5 and the ion generating chamber 1. The interface body 7 is provided with a gas inlet 8. A second electrode 9 formed from an electrically conductive material and having with a narrow central opening 10 is positioned between the ion generating chamber 1 and the interface 7, a body of electrically insulating material 11 being interposed between the ion generating chamber 1 and the conductive second electrode 9.

In addition to the features found in the apparatus of FIG. 2, the apparatus of FIG. 3 further comprises an annular flow conditioner chamber 7b formed inside the hollow interior of the interface body 7 and bounded on its radially inner side by a partition wall 12. There is a narrow gap 13 between an edge of the partition wall 12 and the conductive second electrode 9.

The flow conditioner chamber 7b serves to homogenize the aerosol flow and make it axially symmetrical. The aerosol particles entering the interface body 7 through gas inlet 8 initially face the partition wall 12 and flow around it as a consequence of the pressure drop created by the narrow gap 13. This makes the aerosol flow axially symmetrical inside the interface body 7 and the particle charger 5 and reduces ion losses. A major advantage of the partition wall 12 is an increase in stability of charging and a decrease in ion losses.

The partition wall 12 can be made of a metal or a conductive alloy. The flow distributor may be, for example, of circular cross section, oval cross section or polygonal cross section. The partition wall 12 preferably has axial symmetry. The geometries of the flow conditioner chamber 7b and the partition wall 12 help to provide a uniform laminar flow of the gas stream through the apparatus.

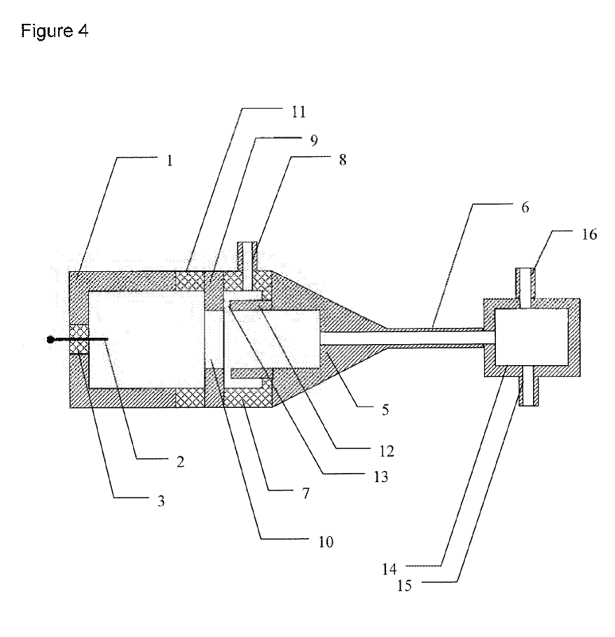

Apparatus according to each the embodiments shown in FIGS. 1 to 3 have been constructed and tested and all showed good long-term performance. However, it was considered that if the aerosol contains chemically active particles having an opposite charge to the corona charge, such particles might be attracted to the first (corona) electrode 2, resulting in deposits which would limit the lifetime of the first electrode. Accordingly, in a fourth embodiment of the invention as shown in FIG. 4, an external particle charging chamber 14 is introduced. This enables clean air (or other carrier gas) rather than an aerosol to be supplied through the gas inlet 8 into the interface body 7. The carrier gas flow carries ions though the chamber 5 (which in this embodiment functions as an intermediate mixing chamber rather than a charging chamber) to the outlet 6 and into the chamber 14 where the ions collide with aerosol particles entering through the aerosol inlet 15. Charged particles are directed to the outlet 16. This arrangement further reduces the potentially adverse effects of reactive particles on the first electrode 2 and increases its long-term stability.

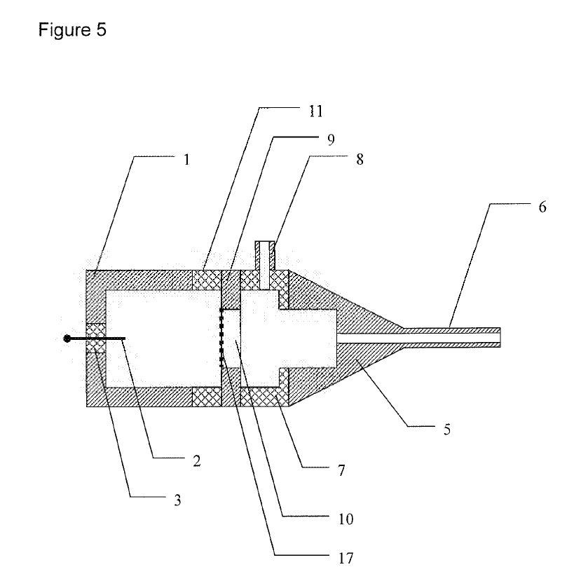

An apparatus according to a fifth embodiment of the invention is illustrated in FIG. 5. The apparatus of FIG. 5 generally corresponds to the apparatus of FIG. 2 in that it shares the common features labelled 1 to 3 and 5 to 11. However, it differs from the apparatus of FIG. 2 in that an electrically conductive mesh 17 is attached to the second electrode 9 so as to cover the central opening 10 in the electrode. The conductive mesh 17 is made from an electrically conductive material and is in electrical connection with the rim of the opening 10. Examples of materials that can be used for the mesh are metals (Au, Ag, Pt) and alloys such as stainless steel or brass. The conductive mesh 17 is at the same electrical potential as the second electrode and assists in controlling the number of ions passing through the opening 10.

The mode of action of each of the embodiments shown in FIGS. 1 to 5 is the same except for the variations described above. Further variations are as described below.

In each of the embodiments illustrated, the cross sectional shape of the main body of the chamber 1 has axial symmetry and thus, for example, can be of circular cross section or regular polygonal cross section. Alternatively, the cross sectional shape of the main body can be rectangular as can the cross sectional shape of the interface 7 and particle charging chamber 5.

In each case, the aerosol particle charging chamber can be at a particular electric potential or grounded.

In each of the embodiments illustrated, the tip of the corona electrode 2 is typically positioned a sufficient distance from the interface chamber 7 to achieve stable performance. In practice this distance is typically from 0.5 D to 3 D where D is the internal diameter of the ion generating chamber 1.

The apparatus can be operated at various ion concentrations controlled by the voltage applied to the electrode 9, which is advantageous for an apparatus used in an SMPS. Variation of the voltage enables the optimal concentrations of ions to be obtained for various particle diameters. This reduces the multiple charging for large particles and increases the charging efficiency of small particle. Thus, variation of the voltage should be related to the size scan of the SMPS. The ion concentration controlled unipolar corona particle charging apparatus used in an SMPS provides the advantage of obtaining size distributions without multiple charges.

The optimal ion concentration needed to reduce multiple charging is influenced by the particle size. Therefore, another aspect of the present invention is a method for charging aerosol particles without multiple charging where the ion concentration is greater for small particles and lower for larger particles. The value of the optimal ion concentration for a given particle size range can be found experimentally.

A further aspect of the invention is a method for effective charging of aerosol particles without multiple charging in a DMA or SMPS where the ion concentration is a function of the particle sizes of the aerosol particles. The relationship between the required ion concentration and the particle sizes of the aerosol particles can readily be determined by the skilled person by routine trial and error studies on different size distributions.

In further embodiments, a plurality of particle charging apparatuses of the invention set up to give different charging conditions can be connected to each other sequentially or in parallel.

### EXAMPLES

Several examples of apparatus according to this invention have been built and tested and these are described below.

### Example 1

An apparatus was built according to the embodiment shown in FIG. 5. All metal parts were made from stainless steel. The non-conductive parts were made of PTFE and a gold electrode of 0.2 mm diameter was used. The internal diameter of the ion generating chamber (item 1 in FIG. 5) was 16 mm. The opening 10 in the second electrode 9 was 2.5 mm in diameter and the thickness of the second electrode 9 was 1.5 mm. The mesh 17 was formed from stainless steel and the openings in the mesh were 120 μm (measured as the diagonal dimension of the opening).

### Example 2

Another example of an apparatus according to the invention was built according to the embodiment shown in FIG. 4. All metal parts were made from stainless steel. The non-conductive parts were made of PTFE and a gold electrode of diameter 0.1 mm was used. The internal diameter of the ion generating chamber 1 was 14 mm. The opening in the second electrode 9 was 2.5 mm in diameter and the thickness of the second electrode 9 was 1.5 mm.

### Example 3

A further example of an apparatus according to the invention was built according to the embodiment shown in FIG. 5. All metal parts were made from stainless steel, the non-conductive parts were made of PTFE and the electrode was made from Au of diameter 0.2 mm. The internal diameter of ion generating chamber 1 was 12 mm. The opening in the second electrode 9 was 3.5 mm and the thickness of the second electrode 9 was 1.5 mm. The mesh was formed from stainless steel and had 120 μm opening (measured as the diagonal of the openings). The aerosol flow rate was 0.2 l/min.

### Test Results

Examples of apparatuses of the invention were tested using Zn, sebacate, ZnO, soot atmospheric aerosols and Cr₂O₃ aerosols. In each case, the ion concentration was measured with an ion counter and the aerosol particle size distributions were obtained with an NPS500 instrument (Naneum).

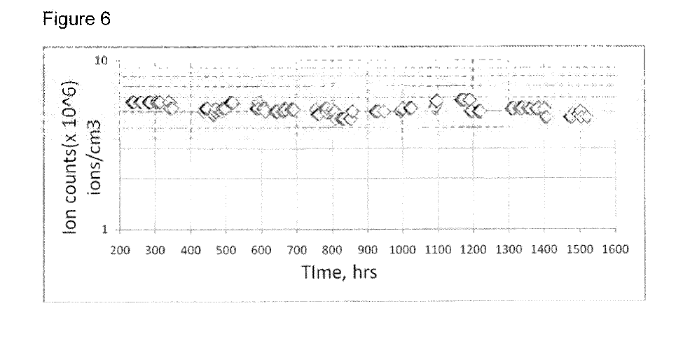

An illustration of the long-term stability of the charging corona (measured using the apparatus of Example 2) is shown in FIG. 6. Here it can be seen that the corona discharge remained stable for at least 1500 hours.

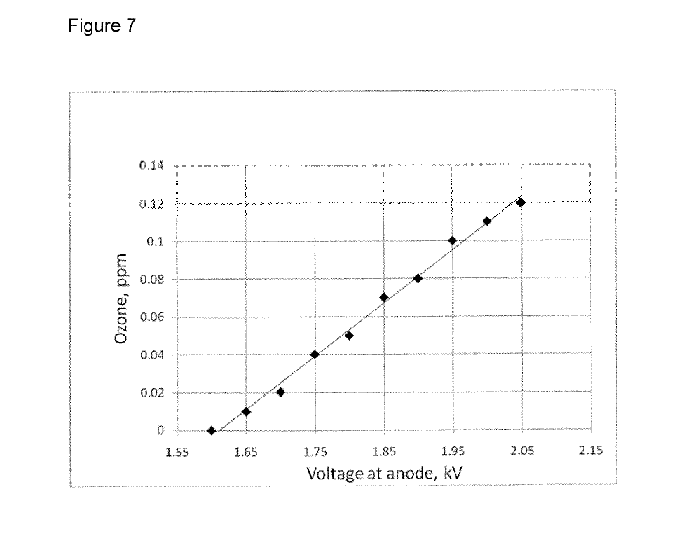

The ozone concentration as a function of the corona voltage is shown in FIG. 7. It can be seen that, in under a normal working regime, when the voltage of the corona is below 1.95 kV, the ozone concentration generated by the corona discharge is less than 0.1 ppm and is consistent with current official occupational health and environmental health guidelines on acceptable limits for ozone concentrations in air.

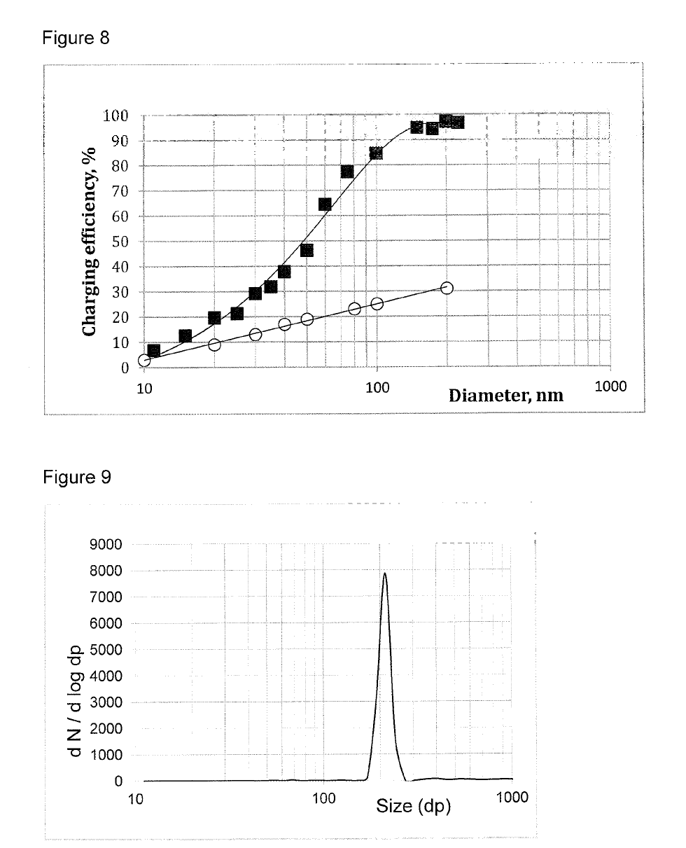

The charging efficiency of the corona apparatus (tested using the apparatus of Example 3) is shown in FIG. 8 from which it can be seen that the efficiency of the apparatus is considerably higher than the charging efficiency of a neutralizer (data points shown as circles). The data were obtained for the positive corona with Cr₂O₃ aerosols.

One of the main advantages of the corona charger of the invention is that it gives rise to a reduction in multiple charging of particles. FIG. 9 presents a typical spectrum of sebacate aerosols of 210 nm cut with a DMA (NPC10, Naneum). There are no multiple charge peaks in the spectrum. It is well known that for a neutralizer charger e.g. ²⁴¹Am for this size, multiple charges account for more than 30% of the total charges on the particles. The data presented in FIG. 9 demonstrate that the apparatus of the invention performs better than a neutralizer charger.

### EQUIVALENTS

It will readily be apparent that numerous modifications and alterations may be made to the specific embodiments of the invention described above without departing from the principles underlying the invention. All such modifications and alterations are intended to be embraced by this application.

1. An apparatus for charging or altering the charge of gas-entrained particles in an aerosol, the apparatus comprising:
(a) an ion generating chamber containing a first electrode for generating a corona discharge, the first electrode being connected to a power supply of sufficiently high voltage to create the corona discharge; the ion generating chamber having an ion outlet through which ions generated by the corona discharge can leave the chamber;
(b) a particle charging chamber in which charging or altering the charge of gas-entrained particles in an aerosol takes place, the particle charging chamber being in fluid communication with the ion generation chamber and having an inlet and an aerosol outlet; and
(c) an electrically non-conductive interface body positioned between the aerosol particle charging chamber and the ion generating chamber, the interface body having a hollow interior which is in fluid communication with the ion generating chamber and the aerosol particle charging chamber, and having a gas inlet through which a stream of gas can be introduced into the hollow interior of the interface body.

2. An apparatus according to claim 1 wherein the gas entering the gas inlet of the interface body contains the gas-entrained particles in an aerosol.

3. An apparatus according to claim 1 wherein the gas entering the gas inlet of the interface body is clean gas and functions as a carrier gas to carry ions into the aerosol particle charging chamber where they will collide with gas-entrained particles introduced through a further inlet in the aerosol particle charging chamber.

4. An apparatus according to claim 1 wherein the first electrode is electrically insulated from a wall or walls defining the ion generating chamber.

5. An apparatus according to claim 1 wherein a second electrode is positioned between the ion generating chamber and the particle charging chamber, the second electrode being connected to a second voltage source to control the movement of ions out of the ion generating chamber.

6. An apparatus according to claim 5 wherein the second electrode is configured so that it constitutes or forms part of an end wall of the ion generating chamber, the wall having an opening therein defining the ion outlet of the ion generating chamber.

7. An apparatus according to claim 1 wherein the hollow interior of the interface body contains a flow conditioning chamber having the gas inlet at an upstream location thereof and a partition wall and an adjacent gap through which gas may flow at a downstream location thereof, the geometry of the flow conditioning chamber, partition wall and gap being selected so as to provide a desired modification to the flow characteristics of the gas stream before it passes through the particle charging chamber.

8. An apparatus according to claim 7 wherein the partition wall in the hollow interior of the interface body is an axially oriented annular wall and the flow conditioning chamber is an annular chamber.

9. An apparatus according to claim 5 wherein an electrically conductive mesh is attached to the second electrode so as to extend across the opening (ion outlet) in the second electrode.

10. An apparatus according to claim 3 comprising an intermediate mixing chamber which is in fluid communication with the gas inlet of the interface body, the ion outlet of the ion generating chamber and the inlet of the particle charging chamber so that, in use, the intermediate mixing chamber receives a mixture of ions and clean gas, the particle charging chamber being located downstream of the intermediate mixing chamber and being provided with a separate inlet for receiving the gas stream containing air-entrained particles.

11. An apparatus for charging or altering the charge of gas-entrained particles in an aerosol, the apparatus comprising:
(a) a first body member comprising an ion generating chamber containing a first electrode for generating a corona discharge, the first electrode being connected to a power supply of sufficiently high voltage to create the corona discharge; the ion generating chamber having an ion outlet through which ions generated by the corona discharge can leave the chamber;
(b) a second body member comprising a particle charging chamber in which charging or altering the charge of gas-entrained particles in an aerosol takes place, the particle charging chamber being in fluid communication with the ion generation chamber and having an inlet and an aerosol outlet; and
(c) an electrically non-conductive interface body positioned between the first and second body members, the interface body having a hollow interior which is in fluid communication with the ion generating chamber and the aerosol particle charging chamber, and having a gas inlet through which a stream of gas can be introduced into the hollow interior of the interface body.

12. An apparatus according to claim 11 wherein the first and second body members and the interface body are arranged contiguously.

13. An apparatus according to claim 11 wherein a third body member, which comprises a second electrode, is interposed between the first body member and the interface body.

14. A method of charging or altering the charge of gas-entrained particles, which method comprises:
forming ions in a first chamber by means of a corona discharge electrode;
introducing a stream of gas into a second chamber, wherein the second chamber is in fluid communication with the first chamber; and either
(i) when the stream of gas contains air-entrained particles, allowing the mixing of ions emerging from an ion outlet in the first chamber with the stream of gas in the second chamber so as to charge or modify the charge of the air-entrained particles; or
(ii) when the stream of gas introduced into the second chamber is substantially free of air-entrained particles, allowing the mixing of ions emerging from an ion outlet in the first chamber with the said stream of gas in the second chamber, passing the mixture of ions and gas into a third chamber located downstream of the second chamber, and contacting the said mixture of ions and gas in the third chamber with an aerosol containing air-entrained particles received through a separate inlet in the third chamber so as to charge or modify the charge of the air-entrained particles.

15. A Differential Mobility Analyzer (DMA) comprising an apparatus as defined in claim 1.

16. A Differential Mobility Particle Sizer (DMPS) comprising a DMA as defined in claim 15.

17. A method of charging or altering the charge of gas-entrained particles, according to claim 14 wherein charging efficiency and/or proportions of multiple charges on the particles are varied, reduced or eliminated according to the size of the particles or the voltage applied to the DMA.

18. A method of charging or altering the charge of gas-entrained particles, according to claim 14 wherein charging efficiency and/or proportions of multiple charges on the particles are varied by changing the current flowing via the first electrode.

19. A method of charging or altering the charge of gas-entrained particles, according to claim 17 wherein charging efficiency and/or proportions of multiple charges on the particles are varied by changing the voltage applied to any of the electrodes of the ion generating chamber.

20. A method of charging or altering the charge of gas-entrained particles, according to claim 19 wherein charging efficiency and/or proportions of multiple charges on the particles are varied by changing the voltage applied to the first electrode.

21. A method of charging or altering the charge of gas-entrained particles, according to claim 14 wherein charging efficiency and/or proportions of multiple charges on the particles are varied by changing the current flowing via the first electrode from a larger current for smaller particles (e.g. 5 nm particles) to a lower current for larger particles (for example 500 nm).
